(19) United States
(12) Patent Application Publication
(10) Pub. No.: US 2014/0123789 A1
(43) Pub. Date: May 8, 2014

(54) ACTUATOR

(71) Applicant: BOSTON DYNAMICS, INC., Waltham, MA (US)

(72) Inventors: Aaron Saunders, Arlington, MA (US); Brian Dellon, West Roxbury, MA (US); Michael Murphy, Waltham, MA (US); Adam Borrell, Framingham, MA (US)

(73) Assignee: BOSTON DYNAMICS, INC., Waltham, MA (US)

(21) Appl. No.: 13/668,792

(22) Filed: Nov. 5, 2012

(51) Int. Cl. F16H 25/12

(52) U.S. Cl. 74/89.23

(57) ABSTRACT

An actuator includes an outer sleeve with at least a pair of helical slots coiling in a first direction, an inner sleeve with at least a pair of helical slots coiling in a second, opposite direction, and a driver including bearings received through the helical slots of the inner sleeve and into the helical slots of the outer sleeve.

### FIELD OF THE INVENTION This invention relates to actuators which convert linear motion to rotational motion and vice versa.

### BACKGROUND OF THE INVENTION

There are many mechanical systems requiring the conversion of linear motion to rotational motion. In one example, a robot forearm may need to rotate using an actuator within an upper arm connected to a shoulder. Helical gears (See. U.S. Pat. No. 5,447,095) are heavy and complex. Some actuators have a limited range of motion. Other actuators occupy too much space. Some suffer from high friction.

### SUMMARY OF THE INVENTION

Aspects of the invention may provide for an actuator which is lightweight, involves few moving parts, and has a range of motion adaptable for numerous applications. The actuator has a form factor which is long and slender and may include rolling elements with low friction. In some examples, an actuator is provided with a range of motion greater than 360°. The actuator may be back drivable and can be used as a differential. in some aspects, the actuator can be designed with integral internal fluid routing using, for example, slip rings.

Featured are counter-rotating helical cams in the form of inner and outer sleeves, each with at least a pair of helical slots therethrough. A driver includes bearing surfaces received through the helical slots of the inner and outer sleeves.

Featured is an actuator comprising an outer sleeve with at least a pair of helical slots running in a first direction an inner sleeve with at least a pair of helical slots running in a second, opposite direction and a driver including bearings received through the helical slots of the inner sleeve and into the helical slots of the outer sleeve.

The helical slots of the sleeves may wrap partially around or more. The helical slots of the inner and outer sleeve may have a constant but different pitch, or a non-constant and different pitch. There can be at least four helical slots in the outer sleeve and four helical slots in the inner sleeve.

The driver may include a cross-member supporting the bearings thereon and a piston extending from the cross-member. In one design, there are a pair of roller bearings on each end of the cross-member, one inner roller bearing of each pair for a helical slot in the inner sleeve, one outer roller bearing of each pair for a helical slot in the outer sleeve. The bearings can be cylindrical bearings. If the slots are tapered, the bearings can be conical bearings. The driver may be hydraulically driven, electrically driven, or mechanically driven.

The driver may include at least two cross members.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of a robot arm showing a use of the actuator of the subject invention in one particular example;

FIG. 2 is a cross-sectional view of an example of an actuator in accordance with the invention;

FIG. 3 is a schematic three dimensional front view of the actuator of FIG. 2;

FIG. 4 is a schematic three dimensional view of the actuator of FIGS. 2-3;

FIG. 5 is a schematic cross-sectional view of the actuator of FIGS. 2-4;

FIG. 6 is a schematic view showing an example of a tapered helical slot in a sleeve and a conical roller bearing in accordance with examples of the invention;

FIG. 7 is a schematic three dimensional front view of the outer sleeve of the actuator;

FIG. 8 is a schematic three dimensional front view of the inner sleeve of the actuator;

FIG. 9 is a schematic three dimensional cross-sectional view of the coaxially nested actuator sleeves;

FIG. 10 is a schematic three dimensional front view of another actuator in accordance with an example of the invention;

FIG. 11 is a schematic three dimensional front view of the driver for the actuator of FIG. 10; and

FIG. 12 is a schematic three dimensional front view of another example of an actuator in accordance with the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

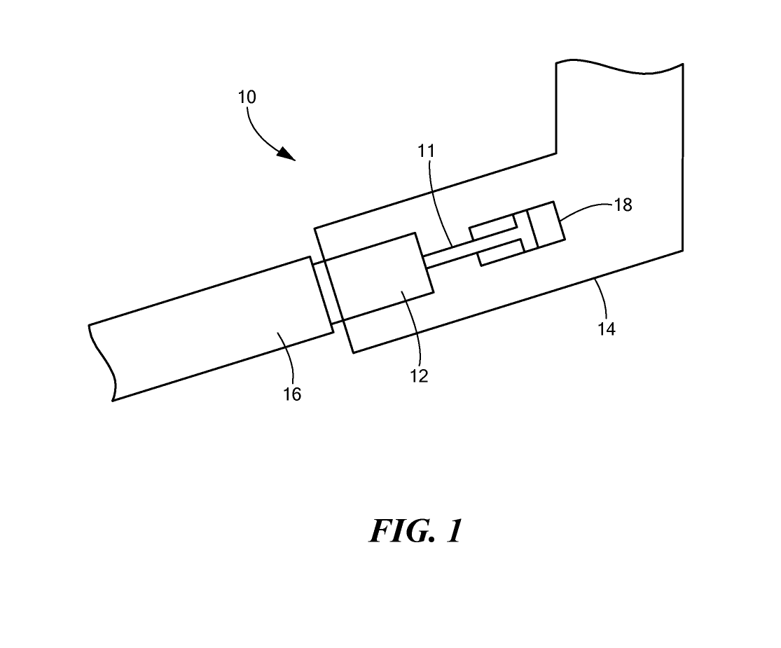

FIG. 1 shows a robot arm 10 with actuator 12 inside upper aim 14 and configured to rotate forearm 16. This is but one use for actuator 12. It may be used in a variety of systems where linear to rotary motion conversion is required (and vice versa). The actuator can also be used as a differential. In one specific example, piston shaft 11 is a component of a linear driver for actuator 12 and piston shaft 11 is hydraulically driven via hydraulic cylinder 18. In other examples, the driver may be electrically driven or mechanically driven. A linear voice coil motor, for example, is possible.

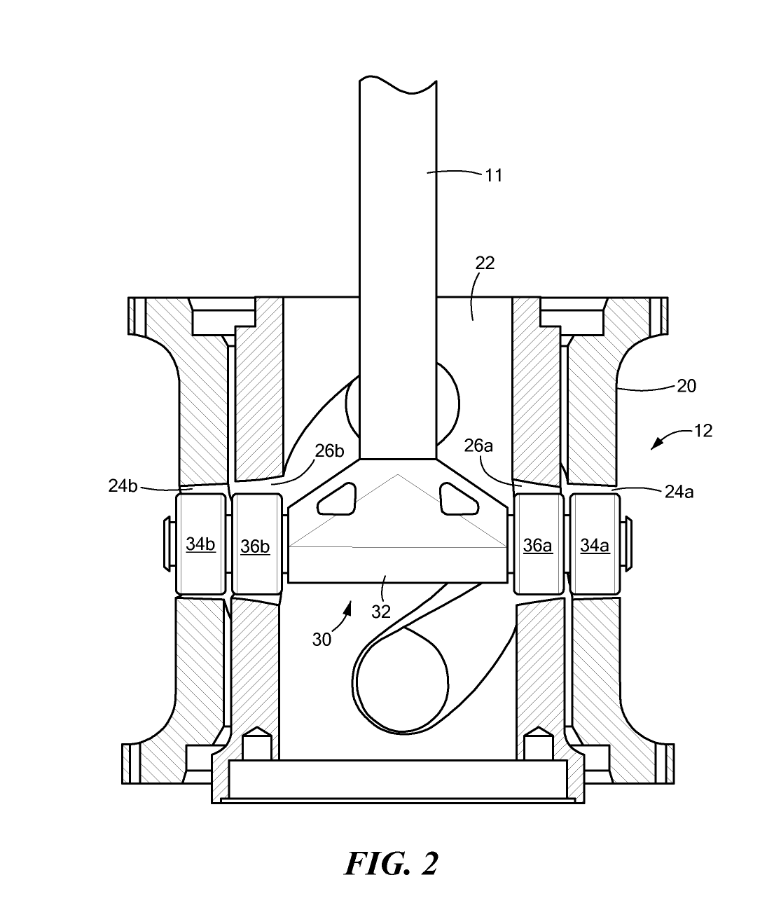

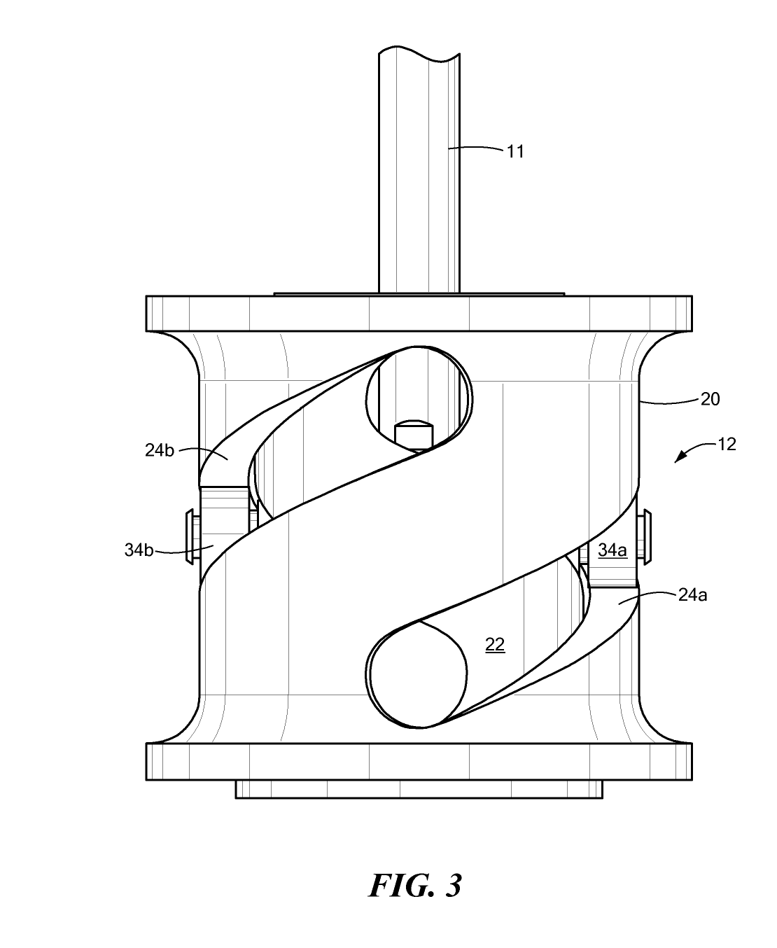

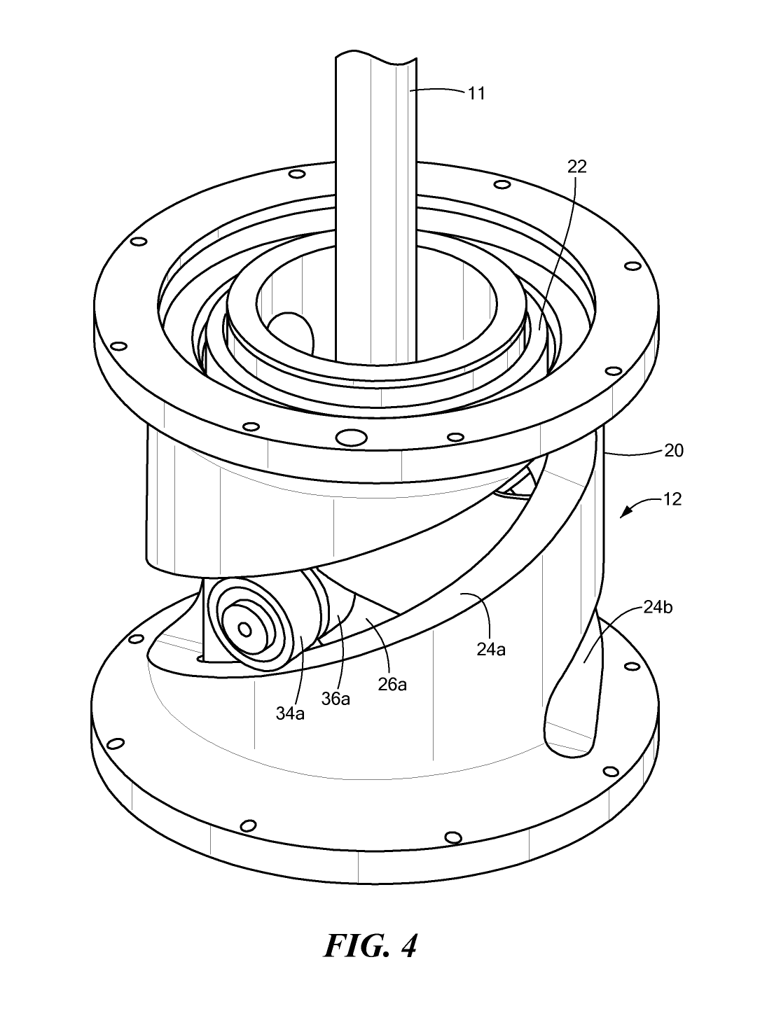

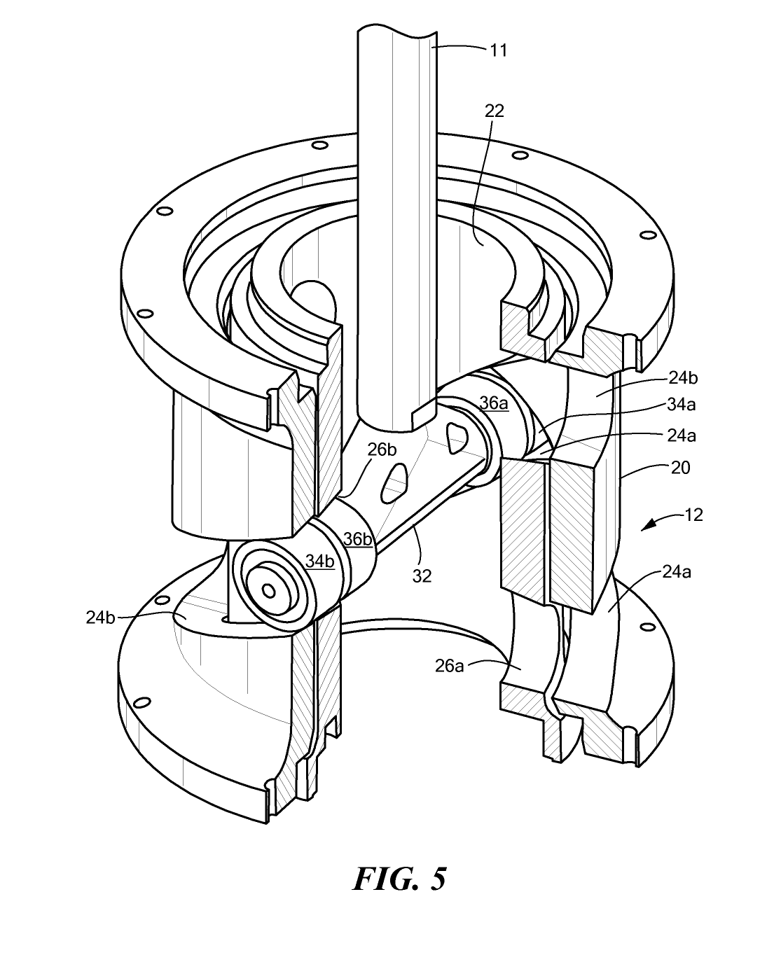

FIGS. 2-5 show actuator 12 comprising outer sleeve 20 and inner sleeve 22. Outer sleeve 20 includes a pair of helical slots 24a and 24b through the wall of the sleeve. Inner sleeve 22 also includes a pair of helical slots 26a and 26b coiled in the opposite direction of the helical slots 24a and 24b in the outer sleeve. Driver 30 includes, in this example, cross-member 32 attached to piston shaft 11 and supporting outer roller journal bearings 34a and 34b riding in helical slots 24a and 24b, respectively, in outer sleeve 20 and inner roller bearings 36a and 36b riding in helical slots 26a and 26b, respectively, of inner sleeve 22. In other designs, the bearing surfaces on the ends of the cross member can include rolling or sliding elements, journal bearings, and sliding shoes of different shapes. If inner sleeve 22 is fixed, linearly driving piston shaft 11 causes outer sleeve 20 to rotate. Conversely, if outer sleeve 20 is fixed, inner sleeve 22 will rotate as piston shaft 11 moves (up and down in the figures).

The helical slots in each sleeve may wrap around their respective sleeves partially, once, or more. They may have a constant pitch as shown. The slots of the inner sleeve may have a different pitch than the slots of the outer sleeve. The helical slots of the outer and inner sleeve may also have a non-constant pitch and again the pitch of the helical slots in the outer sleeve is typically different than the pitch of the helical slots in the inner sleeve creating a non-linear transmission.

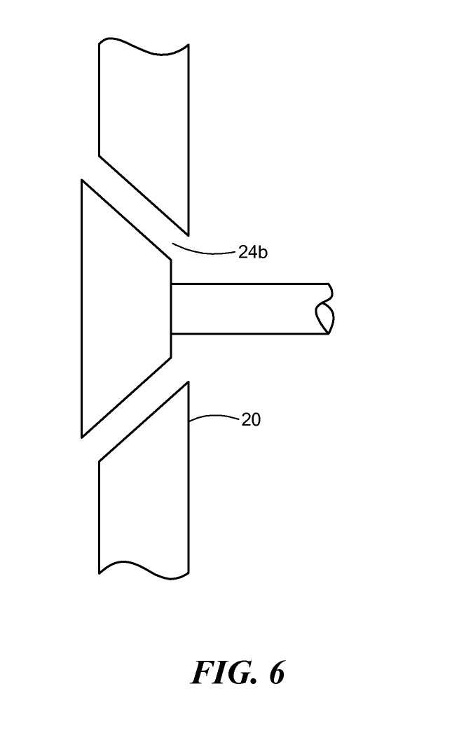

FIG. 6 shows a design where helical slot 14b′ in outer sleeve 20 has a tapered profile and roller bearing 24b′ is conical in shape to match the tapered profile of the slot it rides in. The helix slots of both sleeves may be configured in this fashion and all the roller bearings may be conical in shape.

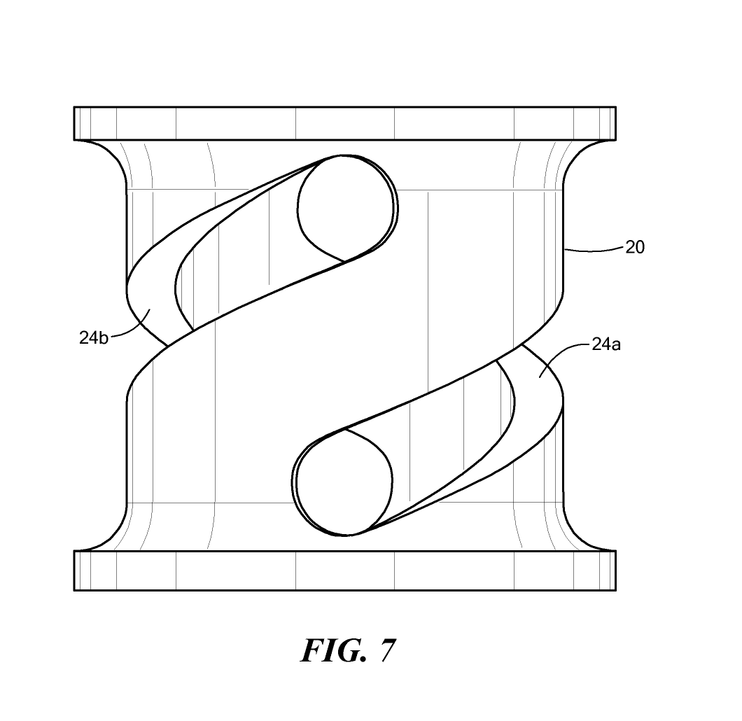

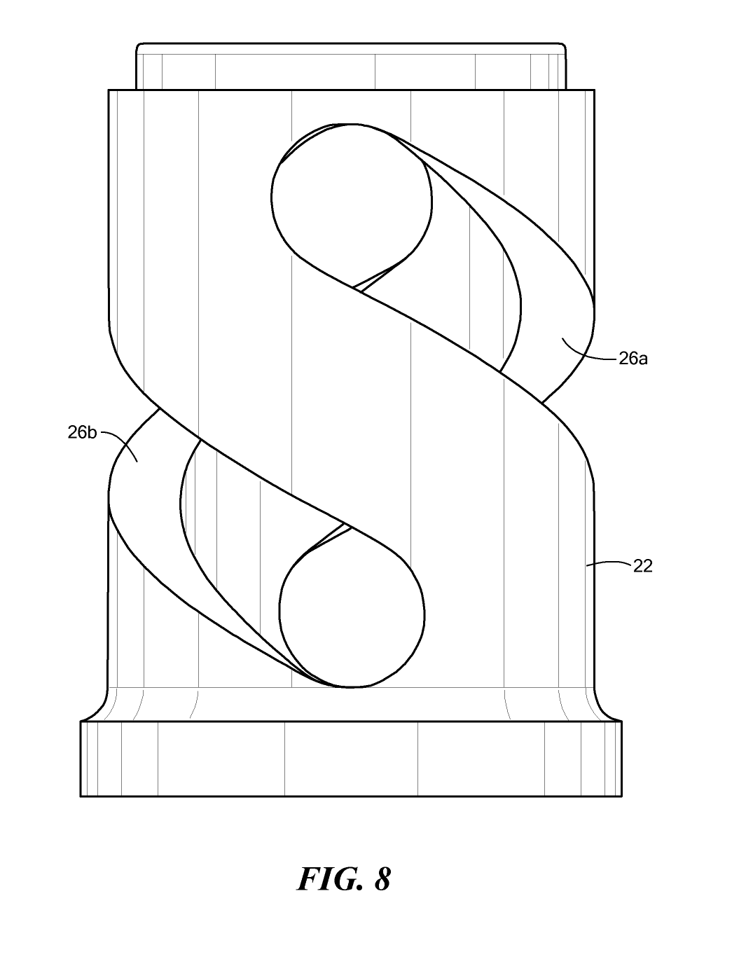

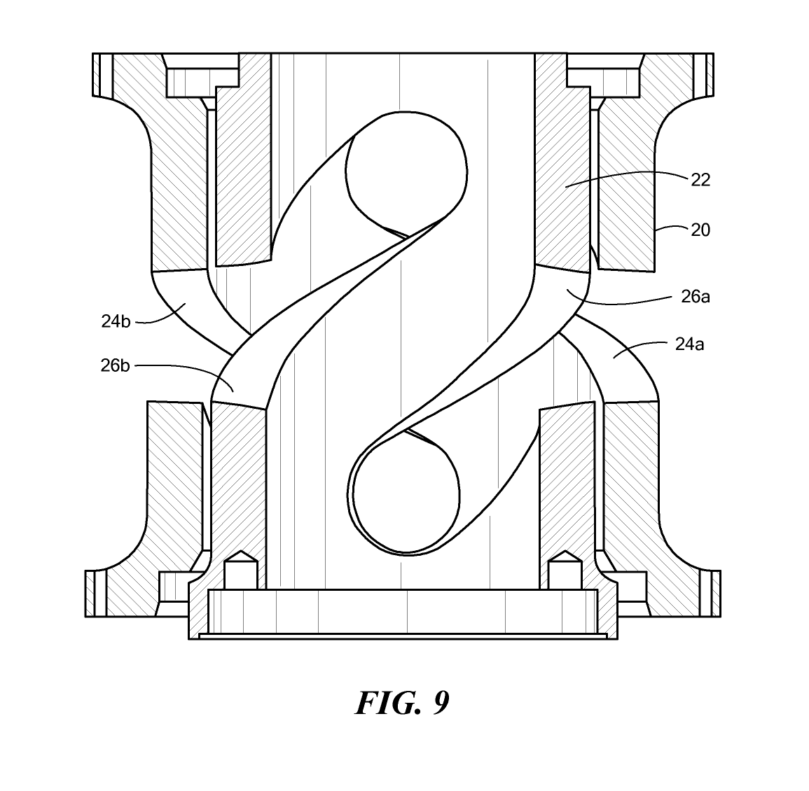

FIG. 7 shows outer sleeves with helical sots 24a and 24b. FIG. 8 shows inner sleeve 22 with helical slots 26a and 26b. FIG. 9 shows both sleeves coaxially disposed in a nested fashion without the driver.

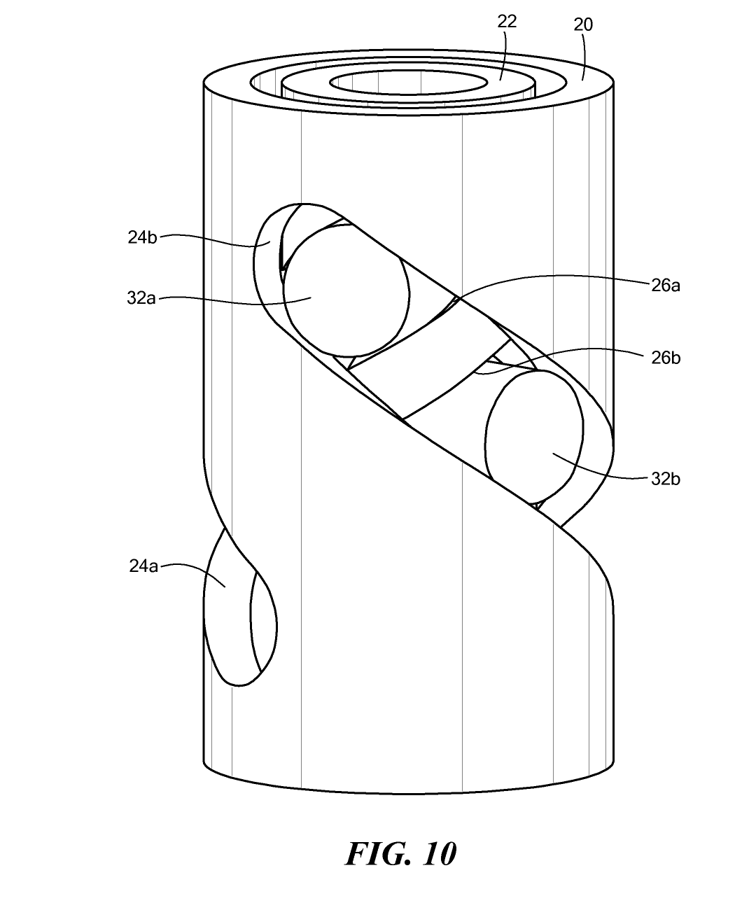

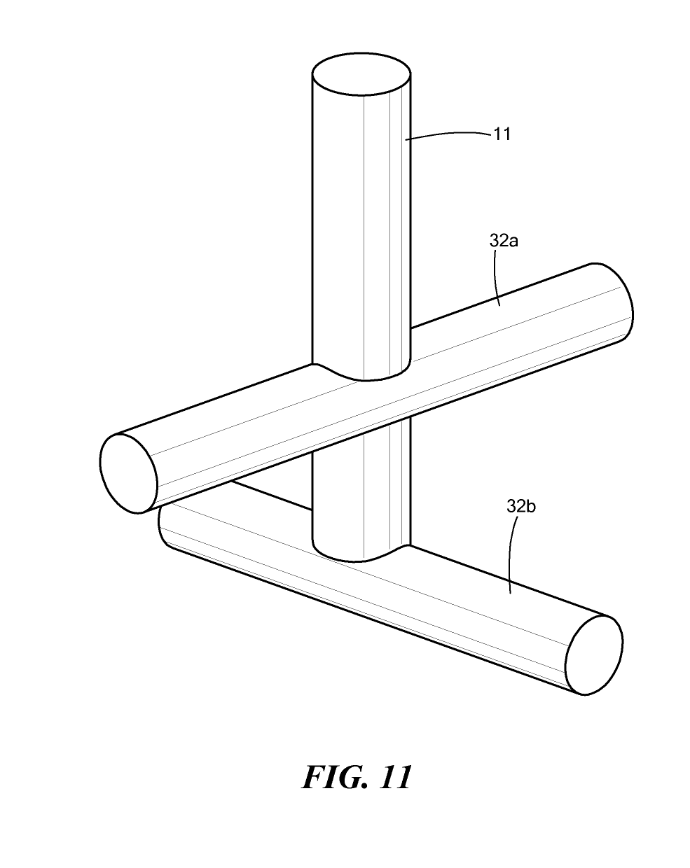

FIG. 10 shows a design with a driver including two spaced offset cross members 32a and 32b for backlash reduction. The driver is also shown in FIG. 11. Here, the bearing surfaces on the ends of the cross members slide in their respective slots in the sleeves.

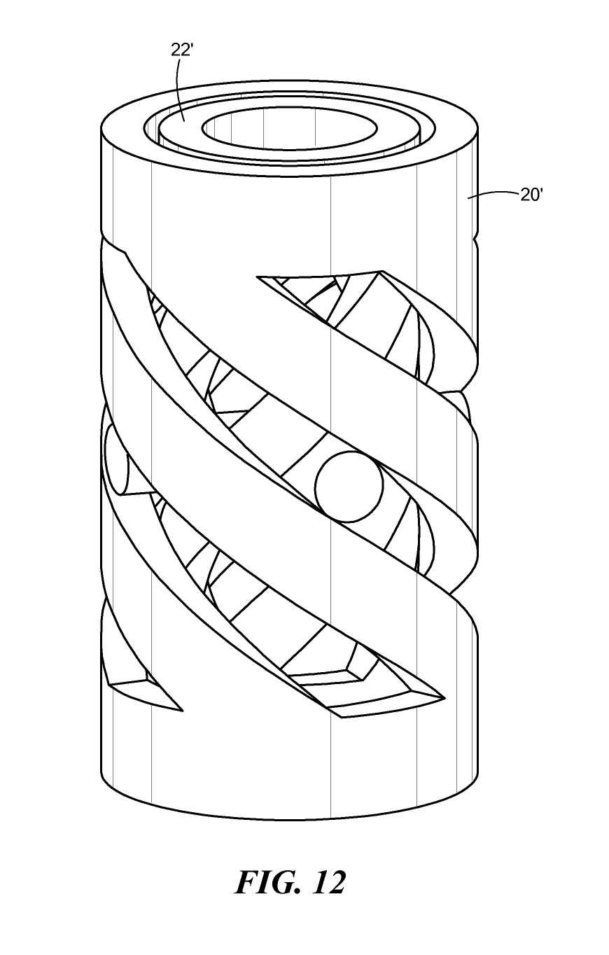

FIG. 12 shows a design where outer sleeve 20′ includes four-start helix pattern (four helical slots) as does inner sleeve 22′. The driver may include two cross members or four.

By integrating internal fluid routing and slip rings, hydraulic fluid can be provided downstream of the actuator, for example, to one or more components in forearm 16, FIG. 1.

The resulting actuator in its various embodiments is lightweight, involves few moving parts, and has an adjustable range of motion suitable for numerous applications. The preferred actuator has a form factor which is long and slender and includes rolling elements with low friction.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An actuator comprising:
an outer sleeve with at least a pair of helical slots coiling in a first direction;
an inner sleeve with at least a pair of helical slots coiling in a second, opposite direction; and
a driver including bearing surfaces received through the helical slots of the inner sleeve and into the helical slots of the outer sleeve.

2. The actuator of claim 1 in which the helical slots of the inner sleeve wrap at least partially around the inner sleeve.

3. The actuator of claim 1 in which the helical slots of the outer sleeve wrap at least partially around the outer sleeve.

4. The actuator of claim 1 in which the helical slots of the outer sleeve have a constant pitch.

5. The actuator of claim 4 in which the helical slots of the inner sleeve have a constant pitch.

6. The actuator of claim 5 in which the constant pitch of the helical slots of the outer sleeve is different than the constant pitch of the helical slots of the inner sleeve.

7. The actuator of claim 1 in which the helical slots of the outer and inner sleeve have a non-constant pitch.

8. The actuator of claim 7 in which the non-constant pitch of the helical slots of the outer sleeve is different than the non-constant pitch of the helical slots of the inner sleeve.

9. The actuator of claim I in which there are at least four helical slots in the outer sleeve and four helical slots in the inner sleeve.

10. The actuator of claim 1 in which in which the driver includes a cross-member supporting said bearing surfaces thereon.

11. The actuator of claim 10 in which the driver further includes a piston extending from the cross-member.

12. The actuator of claim 10 in which the bearing surfaces are roller bearings and there are a pair of roller bearings on each end of the cross-member, one inner roller bearing of each pair for a helical slot in the inner sleeve, one outer roller bearing of each pair for a helical slot in the outer sleeve.

13. The actuator of claim 12 in which said bearings are journal bearings.

14. The actuator of claim 1 in which said slots are tapered.

15. The actuator of claim 14 in which said bearings are conical bearings.

16. The actuator of claim 1 in which in the driver is hydraulically driven.

17. The actuator of claim 1 in which the driver is electrically driven.

18. The actuator of claim 1 in which the driver is mechanically driven.

19. The actuator of claim 1 in which the driver includes at least two cross members.
